(19) United States
(12) Patent Application Publication
(10) Pub. No.: US 2015/0177157 A1
(43) Pub. Date: Jun. 25, 2015

(54) ARTICLE INSPECTION APPARATUS

(71) Applicant: Compac Technologies Limited, Auckland (NZ)

(72) Inventors: Michael Charles Edmondson, Auckland (NZ); Kenneth Barry Moynihan, Auckland (NZ)

(21) Appl. No.: 14/566,561

(22) Filed: Dec. 10, 2014

Related U.S. Application Data
(63) Continuation of application No. PCT/NZ2014/000212, filed on Oct. 3, 2014.

(30) Foreign Application Priority Data
Oct. 4, 2013 (NZ) 616191

(51) Int. Cl. G01N 21/88; G06T 7/00

(52) U.S. Cl. CPC G01N 21/8803; G06T 7/0004

(57) ABSTRACT

A method and apparatus for inspecting the surface of articles and subsequent grading of fruit. The apparatus includes conveying means for conveying an article through an inspection site and rotating the article about a lateral axis of the conveying means as it passes through the inspection site. The conveying means is arranged to convey the article with its longitudinal axis aligned with the longitudinal axis of the conveying means, the total angle of rotation about the lateral axis being limited to substantially 180 degrees. An imaging system has at least one image capture means and image directing means arranged to provide to the image capture means a plurality of different views of the inspection site about the lateral axis of the conveying means. The image capture means is arranged to capture a plurality of images of the article at different rotational angles as it passes through the inspection site.

### PRIORITY CLAIM

This application is a continuation of PCT Application Serial No. PCT/NZ2014/000212 filed on Oct. 3, 2014, which claims priority to New Zealand Application No. 616191 filed Oct. 4, 2013.

### FIELD OF THE INVENTION

This invention relates to a method and apparatus for inspecting the surface of articles and in particular, but not exclusively to a method and apparatus for the surface inspection and subsequent grading of fruit.

### BACKGROUND OF THE INVENTION

Processing lines for articles such as fruit often require different quality articles to be separated. This is an important commercial function, which may be used for example, to distinguish between fruit destined for export and fruit destined for the local market. Manually grading articles is costly, slow and prone to inaccuracies. Thus, automated methods and apparatus for grading articles have been developed.

The use of one or more video cameras is one known method of automatically sensing characteristics of articles. For example, the method and apparatus described in the specification of U.S. Pat. No. 4,825,068 (Suzuki) uses a video camera in conjunction with mirrors to obtain a picture of each article as it travels past the line of sight of the mirrors. The mirrors enable a larger portion of the article, which is typically generally spherically shaped, to be simultaneously viewed by the camera, but some portion of the article remains obscured from view.

US2004/0247193 (Qualtrough) uses one or more cameras together with a mirror arrangement in order to capture images of a spherical fruit as it is rotated through an inspection site. By fully rotating the fruit and capturing images on side of the conveyor, a composite picture of the entire surface of the fruit can be generated. Image processing can then be used to identify defects in the fruit from the composite picture as well as other factors such as color, and size which may be used for grading and sorting of the fruit downstream of the inspection site.

The reference to any prior art in the specification is not, and should not be taken as, an acknowledgement or any form of suggestion that the prior art forms part of the common general knowledge in any country.

### SUMMARY OF THE INVENTION

It is an object of the present invention to provide a method and apparatus for article inspection which will overcome or ameliorate problems with such a present or at least provide the public with a useful choice.

According to one aspect, there is provided an article inspection apparatus including: conveying means for conveying an elongate article through an inspection site and rotating the elongate article about a lateral axis of the conveying means as it passes through the inspection site, the conveying means arranged to convey the elongate article with its longitudinal axis initially aligned with the longitudinal axis of the conveying means and wherein the total angle of rotation about the lateral axis is limited to substantially 180 degrees; an imaging system having at least one image capture means and image directing means arranged to provide to the image capture means a plurality of different views of the inspection site about the lateral axis of the conveying means; the image capture means arranged to capture a plurality of images of the elongate article at different rotational angles as it passes through the inspection site.

Such an arrangement provides good imaging coverage of the surface of elongate articles like cherries with intact stalk and which can only be partially rotated. This aids with defect identification and subsequent grading of such articles.

In an embodiment five views are provided about the lateral axis. This provides reasonably uniform image resolution over the entire surface of an article for the 180 degree rotation, and thereby improving defect detection.

In an embodiment the image capture means is one or more cameras, and the image directing means comprise a plurality of mirrors. This provides a cost effective arrangement for article inspection. The cameras may be arranged to take a series of still images of the views as the article rotates through the inspection site.

In an embodiment, a plurality of article inspection apparatus are provided in parallel in order to increase the inspection rate of the articles. The image directing means of each inspection apparatus may be arranged to overlap such that the combined width of the plurality of inspection apparatus is less than the total of their individual width in order to provide a more compact system.

According to another aspect there is provided a method of article inspection including: conveying an elongate article through an inspection site and rotating the elongate article about a lateral axis as it passes through the inspection site, and wherein the total angle of rotation about the lateral axis is limited to substantially 180 degrees; capturing a plurality of images of the elongate article at different rotational angles as it passes through the inspection site, the images including a plurality of different views of the inspection site about the lateral axis.

In an embodiment, the views are provided at substantially the same longitudinal location on the conveying means.

In an alternative embodiment, the views are distributed along two or more longitudinal locations on the conveying means. In one arrangement left-hand views are provided to an image capture means at a first longitudinal location and the right-hand views are provided to a second image capture means at a second longitudinal location. This allows images to be captured for substantially or nominally the first 90 degrees of rotation about the first location and images for substantially or nominally the second 90 degrees of rotation about a second location. This reduces the rate of rotation required, which improves control of the articles through the inspection site. Faster rotation can cause the articles to jump between conveying means pockets, or it can make it more difficult to rotate by 180 degrees due to slipping. A further advantage is that by slowing down rotation, more images of the fruit surface can be captured for the same frame-rate camera.

In another aspect there is provided an article inspection apparatus including: conveying means for conveying an article through an inspection site and rotating the article about a lateral axis of the conveying means as it passes through the inspection site; an imaging system having at least one image capture means and image directing means arranged to provide to the image capture means a plurality of different views of the inspection site about the lateral axis of the conveying means; the image system further arranged to provide the different views at two or more longitudinal positions along the conveying means; the image capture means arranged to capture a plurality of images of the article at different rotational angles as it passes through the inspection site.

Such an arrangement allows for the reduction of the rate of rotation required, which improves control of the articles through the inspection site. Faster rotation can cause the articles to jump between conveying means pockets, or it can make it more difficult to rotate by 180 degrees due to slipping. A further advantage is that by slowing down rotation, more images of the fruit surface can be captured for the same frame-rate camera.

In an embodiment, left-hand views are provided to an image capture means at a first longitudinal location and the right-hand views are provided to a second image capture means at a second longitudinal location.

In an embodiment, the article is elongate and the rotation is limited to substantially 180 degrees.

In an embodiment, five views are provided about the lateral axis. In another aspect there is provided an article inspection apparatus including: conveying means for conveying an article through an inspection site and rotating the article as it passes through the inspection site; an imaging system having at least one image capture means and image directing means arranged to provide to the image capture means five different views of the inspection site about the lateral axis of the conveying means.

The use of five different views improves surface inspection coverage of the article whilst maintaining reasonable cost both in terms of capital cost and maintenance cost.

In an embodiment the image system is further arranged to provide the different views at two or more longitudinal positions along the conveying means; the image capture means being arranged to capture a plurality of images of the article at different rotational angles as it passes through the inspection site.

In an embodiment, the views are provided at substantially the same longitudinal location on the conveying means.

In an embodiment the article is rotated about a lateral axis of the conveying means as it passes through the inspection site. In an alternative arrangement the article may be rotated about a longitudinal axis.

In an embodiment the image capture means is one or more cameras, and the image directing means comprise a plurality of mirrors.

In an embodiment the conveying means is arranged to convey an elongate article with its longitudinal axis aligned with the longitudinal axis of the conveying means and wherein the total angle of rotation about the lateral axis is limited to substantially 180 degrees.

In another aspect there is provided a method of operating an article inspection apparatus including: conveying an article through an inspection site and rotating the article as it passes through the inspection site; capturing images of five different views about a lateral axis of the conveying means.

The invention may also be said broadly to consist in the parts, elements and features referred to or indicated in the specification individually or collectively, in any or all combinations of two or more of said parts, elements, or features, and where specific integers are mentioned herein which have known equivalent in the art to which the invention relates, such known equivalents are deemed to be incorporated herein as if individually set forth.

Further aspects of the present invention, which should be considered in all its novel aspects, may become apparent from the following description, given by way of example only with reference to the accompanying drawings.

### BRIEF DESCRIPTION OF THE DRAWINGS

FIG. 1: Shows a cross sectional view of an article inspection apparatus according to an embodiment.

FIG. 1a: Shows a cross sectional view of an article inspection apparatus according to another embodiment.

FIG. 2: Shows a side view of the article inspection apparatus of FIG. 1.

FIG. 3: Shows a top view of the article inspection apparatus of FIG. 1.

FIG. 4a: Illustrates different views employed by an embodiment.

FIG. 4b: Is a detail of FIG. 4a.

FIG. 5: Illustrates the viewing resolution versus the viewing angle of the embodiment of FIGS. 4a and 4b.

FIG. 6: Illustrates an article inspection apparatus having a plurality of lanes.

FIG. 7a: Shows a side view of an article inspection apparatus according to another embodiment.

FIG. 7b: Shows a cross sectional view of the article inspection apparatus of FIG. 7a.

FIG. 7c: Shows a top or plan view of the article inspection apparatus of FIGS. 7a and 7b.

FIG. 8: Shows an article inspection apparatus according to yet another embodiment.

FIG. 9 Shows a diagrammatic side view of an article inspection apparatus of another embodiment.

FIG. 10 Shows a diagrammatic plan view of the embodiment shown in FIG. 9.

### DETAILED DESCRIPTION OF THE PREFERRED EMBODIMENT

The present invention relates to an apparatus and method for inspecting the surface of articles. The present invention may have application to the detection of features on the surface of fruit, vegetables or other articles for grading purposes. In particular, some embodiments of the present invention are envisaged to be particularly suited to the analysis of the surface of opaque articles that have a generally elongate cross section along at least one axis so that the article may have limited rotational freedom about this axis. Therefore, the present invention may have particular application to articles such as cherries with intact stalk and other articles having a similar shape. Other embodiments are envisaged to be suited to analysis of the surface of any shape article requiring reduced rotation rates for example to reduce slippage or misalignment. However, those skilled in the relevant arts may find applications of the present invention elsewhere.

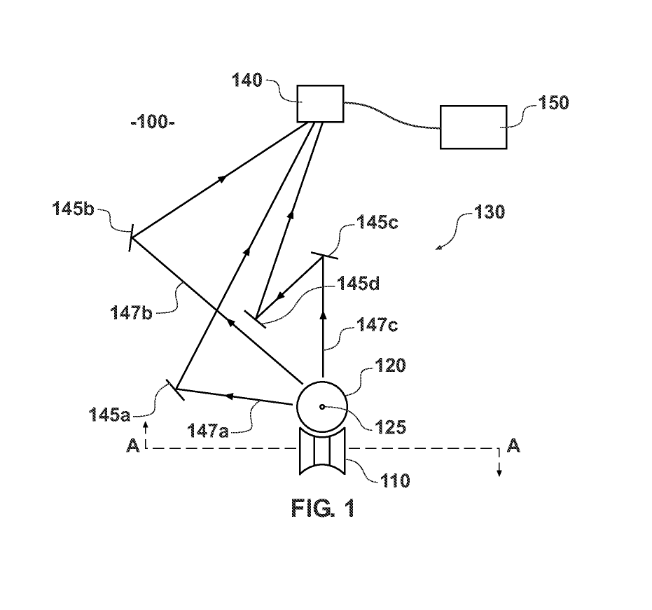

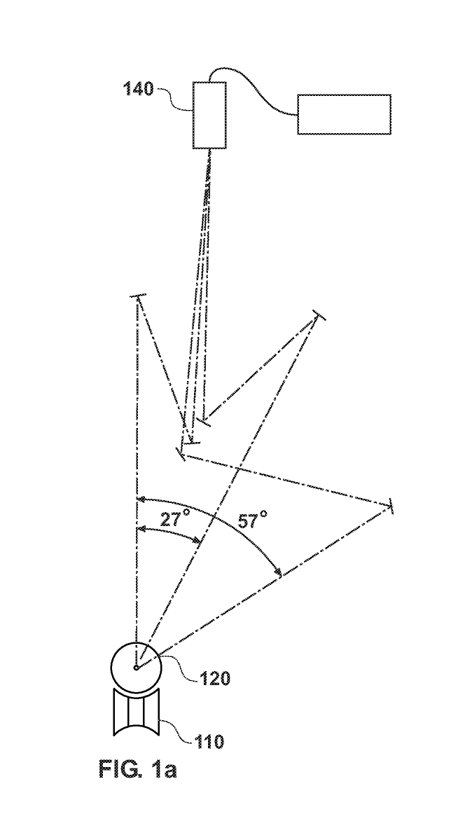

Referring first to FIG. 1, part of an article inspection apparatus 100 according to an embodiment is shown. The apparatus includes suitable image capture means, for example a camera 140 to receive light from an article 120. The camera 140 may be a standard CCD color camera. The camera 140 receives light via first, second and third optical paths, represented by 147a, 147b, 147c respectively. The camera 140 therefore has a field of view that includes both a top view and upper and lower side views of the article 120. Mirrors 145a, 145b, 145c and 145d are provided to guide light from the article 120, located at an inspection site 130, to the camera 140. Optical paths 147a, 147b, 147c preferably have equal path lengths to ensure an equal degree of focus for images acquired from these three views and maintain consistent longitudinal location across these views. For simplicity, the mirrors 145a, 145b, 145c preferably have zero curvature. Each light path intersects the same number of mirrors to maintain consistent light intensity due to parasitic loses of surface interaction. The consistent light intensity allows the maximum CCD/CMOS quantization efficiency across three views. Alternatively as shown in FIG. 1 different numbers of mirrors can be used for each path, and in this embodiment one mirror for paths 147a and 147b, and two mirrors for path 147c.

In this embodiment FIG. 1 shows the left half of an imaging system for capturing a plurality of images of the article from different views. Three views are provided for using the mirrors or imaging directing means shown in FIG. 1, with optical paths 147a, 147b, 147c corresponding to the three views provided to the image capture means 140. A plurality of images of the article 120 are captured at different rotational angles and at the three laterally separated views as it passes through the inspection site. In this example, the elongate articles are cherries 120 with an intact stalk 125, and which are rotated 180 degrees through the inspection site.

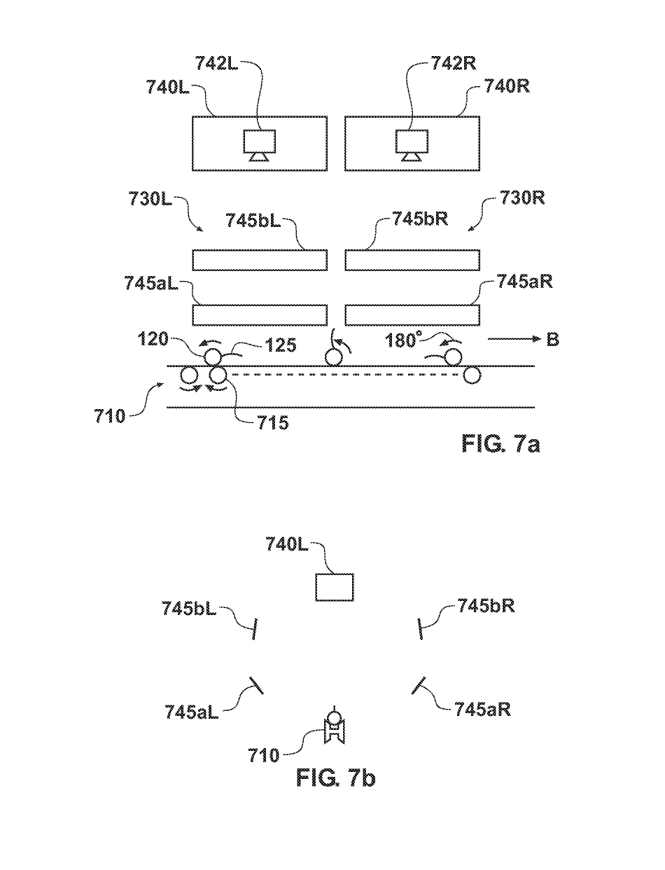

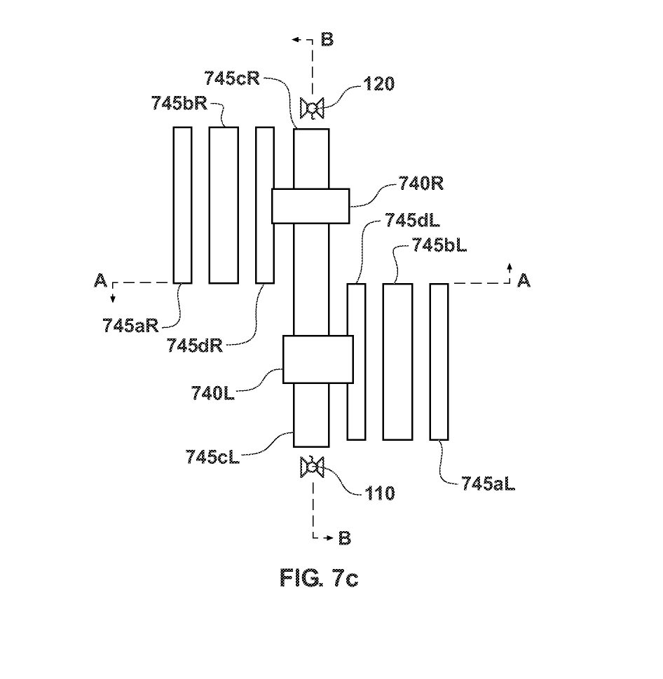

Right hand side views may be provided and corresponding article images captured with a corresponding imaging system on the other side; essentially a mirror arrangement to that shown. The imaging systems capturing left hand and right hand side views of the articles may be located at the same section of the conveying means 110 as illustrated in FIG. 3. In alternative embodiments the left hand side views and right hand side views may be provided for at different locations along the conveying means as illustrated in FIGS. 7a-c.

FIG. 1a shows a right hand part of an imaging system according to another embodiment in which the same number of mirrors (two) are used for each view or path. An arrangement of mirrors which provide viewing angles of 0, +/−24 to 31 degrees (preferably 27.5), and +/−51 to 58 degrees (preferably 54.5) works well in practice to achieve a good level of article coverage whilst maintaining an acceptable level of complexity and cost.

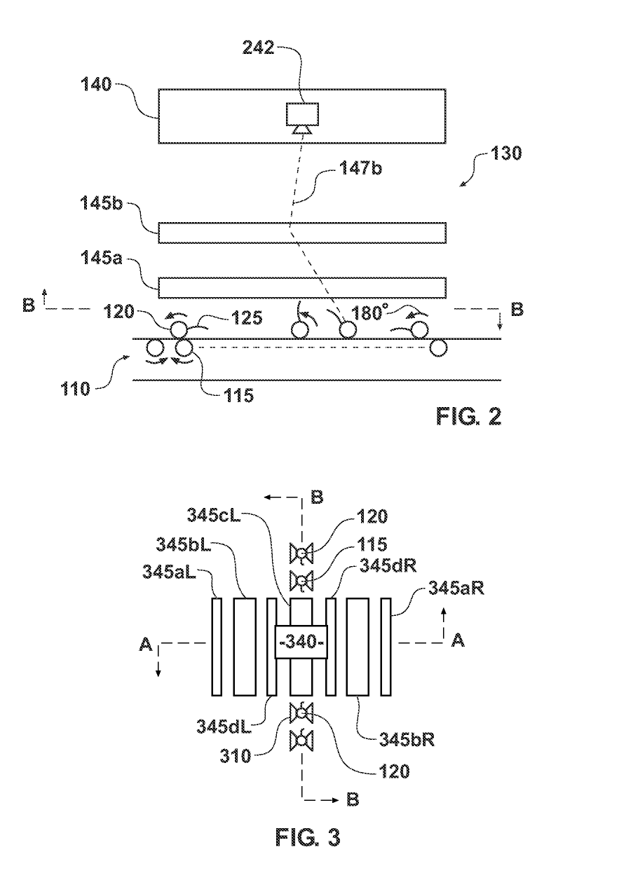

FIGS. 2 and 3 show left and right imaging systems at the same longitudinal location of the conveying means in order to provide 5 views at different lateral angles about the conveyer. FIG. 2 is a side view of an inspection site 130 of the article inspection apparatus of FIG. 1. The conveying means 110 comprises a number of pockets formed by rollers 115 for carrying an elongate article such as a cherry 120 with intact stalk 125. The cherries have a longitudinal axis which is initially aligned with the longitudinal axis B of the conveying means. The cherries are rotated substantially 180 degrees about a lateral axis whilst moving through the inspection site 130. The rollers are arranged to maintain the cherries in a static position relative to the conveying means before approaching the inspection site, but then to rotate the cherries about a lateral axis A of the conveying means whilst passing through the inspection site, and then again to be maintained in a static relative position downstream of the inspection site, preferably with the longitudinal axis of the cherries again aligned with longitudinal axis B. Those skilled in the art will appreciate that, when viewed from above, the longitudinal axis of the cherry remains aligned with axis B throughout the rotation about the lateral axis.

Such conveying means are commercially available, for example from Compac Sort as part of their multi-lane sorter product and similar commercially available products. FIG. 2 also shows side views of mirrors 145a and 145b together with the image capture means 140 which may comprise a single or multiple cameras 242. Additional mirrors and lenses may also be provided as part of the image capture means 140. The view 147a provided by mirror 145a is also illustrated.

FIG. 3 shows a top or plan view of the embodiment of FIGS. 1 and 2, showing both left and right side mirrors 345aL, 345bL, 345cL, 345d, 345aR, 345bR, 345dR. As can be seen the left side imaging system and the right side imaging system provide views that are at substantially the same longitudinal location on the conveying means. In this embodiment five views are provided about the lateral axis of the conveying means in order to capture a plurality of images of the cherry or other elongate articles at different rotational angles as they pass through the inspection site.

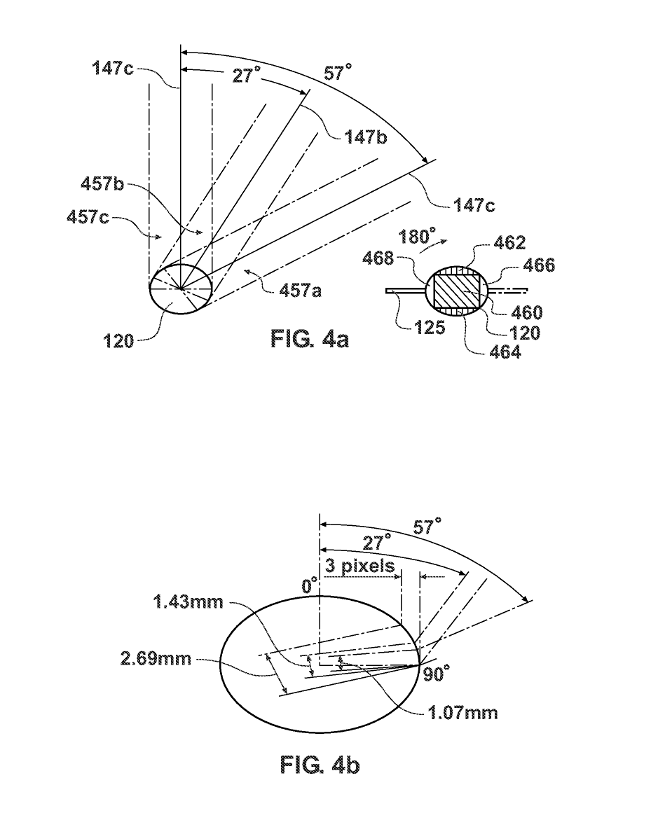

FIGS. 4a and 4b illustrate views and images provided by this embodiment in more detail. The additional side mirrors 345aL and 345aR provide two additional views at low angles compared with known arrangements which provide reasonably uniform image resolution over the entire surface of the article for the 180 degree rotation. This in turn enables improved defect detection by the image capture means. Typically both optical/color and infrared cameras would be employed and used for defect detection, however for simplicity of explanation only one camera is illustrated. Typically cherries are positioned on the conveying means with stem forward and rotated 180 degrees under the image capture means to have stem facing backwards. In the embodiment the image directing means (e.g. mirrors) of the imaging system are arranged to provide views from above the conveying means (0 degrees), at 27.5 degrees left and right of the top view, and at 54.5 degrees left and right of the top view. This provides high resolution views over the entire surface but whilst at the same time avoiding too low an angle for the mirrors which might attract dust, dirt and other debris thereby impacting on future imaging capabilities.

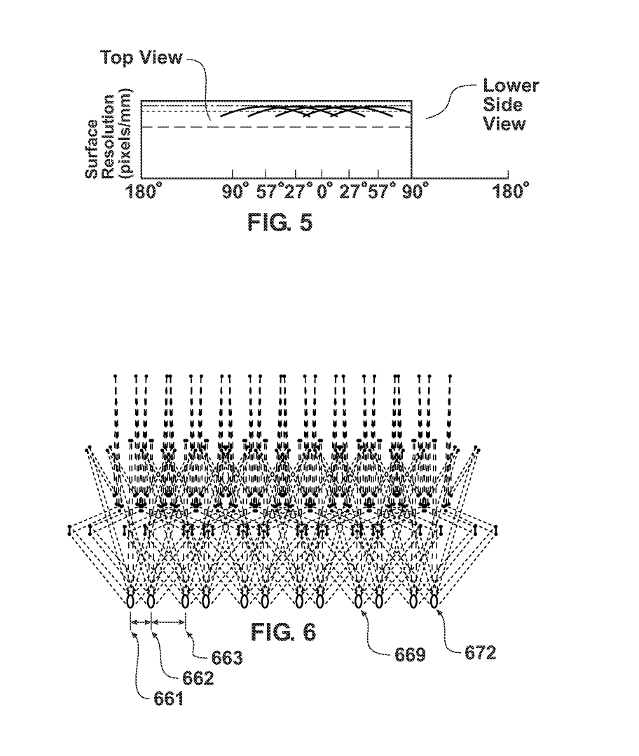

Three surface views of the cherry are indicated generally by 457a, 457b, 457c corresponding to the optical pathways 147a, 147b, 147c. Each of the views is provided to the image capture means or camera in adjacent strips on the cameras image collecting surface. Providing an additional view on each side improves the effective resolution of the views of the side of the cherries by providing substantially the same number of camera pixels for each side view as the top view. Adding such a wide angle view allows the image resolution to be kept as high as possible, and reasonably uniform over the entire cherry surface. This is illustrated in FIG. 5 which shows resolution in pixels per millimetre of cherry surface versus the viewing angles. By rotating the cherries through 180 degrees, substantially all of the surface area of the cherries is captured in a plurality of images by the image capture means. These images are then passed to an image processing unit 150 which identifies defects such as pitting, discoloration, cuts and other factors as would be appreciated by those skilled in the art. Such image processing units are commercially available, for example the Compac Sort Invision 9000 system and other commercially available products.

The detail in FIG. 4a shows a top view (0 degrees) for a cherry, and also parts of the upper left and right (+/−27.5 degree) views. The camera captures an image of the available views—as shown, image of top (0 degrees) view 460, image (only partially shown) of upper right (+27 degrees) view 462, and image (only partially shown) of upper right (−27.5 degrees) view 464. Fruit surface covered by an earlier image 466 and a later image 468 are also shown. Typically the earlier, current and later images will overlap in order to ensure full fruit surface coverage.

The articles are carried through the inspection site on a conveying means such as a conveyor 110, which rotates the article 120 during inspection. The conveying means may achieve this rotation through the provision of a number of substantially equally spaced rollers. A suitable conveyor for this purpose is described in international publication number WO 94/14547, which may also be used to direct graded articles to specific locations under the control of a suitable controller. Other conveying means such as individual trolleys may be used if required.

In an alternative embodiment, the mirrors 145a, 145b may be replaced with cameras if higher resolution is required; the additional resolution obtained at the cost of having to provide additional cameras.

Those skilled in the art will recognize that baffling, aperture stops and the like may be added to the system to prevent stray light entering the camera 1 from other sources. Also support structures will be provided to locate the mirrors 145a-d and camera 140 in position above the conveyor 110. The support structures may be of any suitable form that does not interfere with the optical paths from the article 120 to the camera 140 and also does not interfere with the lighting of the articles.

By having three optical paths with three corresponding views, an increased surface area of the article 140 may be viewed by a single camera. In addition, as each optical path intersects the article 140 at an angle that is substantially normal to the fruit surface, the effects due to the spherical shape of the article 140 are reduced. In combination with rotation of the article 120 on the conveyor 110, all of the surface of the article 120 may be viewed. This may be particularly advantageous for fruit, when features such as defects (for example cuts or splits) of less than one millimetre across may affect the fruit's grade. Such small defects may easily be missed if the system does not view the entire surface of the fruit.

FIG. 5 illustrates the viewing resolution versus the viewing angle of this embodiment. As can be seen the resolution is substantially uniform across the −90 to +90 degrees viewing angles used. This simplifies the image processing requirement and enhances the embodiment's ability to detect defects across all of the article's surface.

Each field of view may overlap with its adjacent field of view to the extent that for most articles two views of the portion of the article 120 to be analysed are captured at each stage of rotation. This may be advantageous during image analysis. For example the or each camera may take multiple images of any surface features as the article 5 travels along the conveyor. Almost all surface features will be seen by the camera from the side and top views. A processing means 150 may then select the best image or combination of best images for analysis purposes, the selection process being performed according to some predetermined criteria, which may include the size and position the feature occupies in the image. Using only the best images for analysis purposes may increase the reliability of the feature identification process.

Light sources are provided to illuminate the article 120 so that the camera 140 may adequately detect the surface characteristics of the article. The light sources may be fluorescent tubes or linear LED extending longitudinally along the conveyor 110 and located so as to not obscure the article from the camera 140.

FIG. 6 shows an article inspection apparatus having a plurality of lanes or conveying means each passing through a parallel inspection site with corresponding image capture means and imaging systems. By appropriate arrangement of the mirrors or other image directing means, the lanes may be grouped more closely together by overlapping the mirrors, than would be otherwise be possible by combining individual article inspection apparatus. This allows the multi-lane or multi-conveyer article inspection apparatus to be more compact than would otherwise be possible. FIG. 6 shows twelve parallel lanes 661-672.

Referring to FIGS. 7a, 7b and 7c, a side view of an inspection apparatus according to another embodiment is shown. In this embodiment the left hand views and the right hand views are separated along the conveying means. FIG. 7a shows a side view in which top, upper and lower left views are provided to a first image capture means 740L using an appropriate arrangement of mirrors, including 745aL and 745bL. Meanwhile the elongate article is rotated substantially 90 degrees through this initial part of the inspection site 730L. In the second part of the inspection site 730R a second image capture means 740R is provided together with side mirrors 745aR and 745bR which together provide for three views, top and two side views of the cherry as it is rotated a further 90 degrees through the inspection site. A plurality of images of the cherry at different rotational angles is captured and provided to an image processing unit as previously described. A cross sectional view of this arrangement is shown in FIG. 7b, and a top or plan view in FIG. 7c.

By providing the different views of the rotating article at two (or more) longitudinal positions along the conveying means, the rotational speed of the article can be reduced resulting in improved handling of the article. This also allows a slower, cheaper camera to be used and results in less motion blur of surface details. The embodiment may be adapted to elongate articles such as cherries with intact stalk so that total rotation is limited to substantially 180 degrees. However, other types and shapes of articles may also be imaged through such an apparatus and different total rotational angles employed.

An advantage in extending the longitudinal length of the conveyer over which an elongate article is rotated, is to enhance the stability of this rotation. Because such articles are not rotated prior to the inspection site, suddenly rotating the rollers to rotate the article can result in slipping of the roller with respect to the article before sufficient friction results in rotating of the article itself. The point at which the article itself starts to rotate is randomly distributed across a large number of articles so that in prior known single inspection site systems the rollers have typically been controlled to rotate at a higher speed than required in order to ensure that the elongate article completes a full 180 degree rotation even if this is delayed. However a problem with this approach is that when a cherry or similar elongate article completes its 180 degree rotation before the end of the inspection site, the continued rotation of the rollers carrying the article can cause this to jump out of the pocket in which it is carried into an adjacent pocket resulting in imaging problems as well as conveying problems and wastage particularly if the pocket is already occupied by another cherry. Slowing down the rotational speed of the rollers reduces slippage at the start of the rotation and also limits jumping out of the pocket at the end of the rotation. There will still be some variation in when individual cherries start to rotate, however by appropriate control of the roller rotational speed and arrangement of the inspection site a full 180 degree rotation for every cherry passing through the inspection sites 730L and 730R is more certain. As a result of this, imaging and defect detection is improved and wastage of articles is reduced.

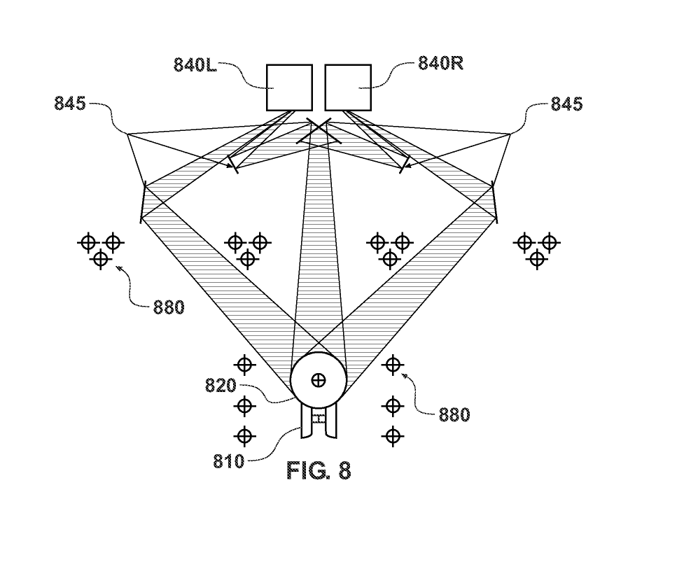

A further embodiment which employs only two side cameras but positions these at different longitudinal positions along the conveying means is shown in FIG. 8. The fields of view of the cameras 840L and 840R are separated along the path of the conveyor 810 so that each camera views the article 820 when it is in a different position along the conveyor. The cameras 840L and 840R are preferably positioned to have an overlap to prevent any part of the surface of the articles 820 being missed.

A processing means 150, such as a digital signal processor, microprocessor or similar receives the information from the cameras 840L and 840R and tracks the movement of the article from the views of camera 840L into the views of camera 840R. Sequences of images from camera 840L and camera 840R form a composite image of the surface of the article. The processing means analyses a band from the image of each frame taken by the cameras. By rotating the article while it is within the field of view of each camera, a full picture of the entire surface of the article may be obtained.

Regarding the top views from each of the cameras only, while processing images from only one camera, the processing means 150 need only process a constant-sized region of each top view image it acquires. The width W of this region is equal to the product of the rotational speed and the camera imaging period. It is independent of the rotational diameter of the article 820. A larger article will take longer to complete a full rotation than a small article, but the width of each region processed is the same. For cherries the diameters would be similar.

The processing means 150 may use geometric and timing considerations to identify the top view images from each of the cameras 840L, 840R that should be analysed. The sequence of side view images from each camera will contain substantially the same region near the article's axis of rotation, repeated from many perspectives. Therefore, analysis of the side view images of the article may be formed by averaging over the image sequence. Alternatively, the analysis of the side view images may be formed by selecting one or more images from the image sequence, or extracting segments from each image to create a composite image.

When processing of the top views transfers from the camera 840L to camera 840R, the width of either the last region processed from camera 840L, or the first region processed from camera 840R, or both, will not be the normal width W. An adjusted width W′ may be calculated taking into account factors such as the camera height, separation and viewing angles (parallax), the overlap distance between the camera fields of view, the rate at which the processing means acquires images from the cameras, the linear and rotational speeds of the article, the size, shape and curvature of the article, and so on. The value of W′ is dependent on the specific geometry of the imaging system, conveying system, and articles. The degree of precision required in establishing W′ will also vary between applications, allowing a variety of approximations, or even non-geometrical techniques (for example image correlation), in its calculation.

In one embodiment, the height of the cameras above the conveyor is established through a calibration process. The fields of view of the cameras are also aligned so as to overlap by a predetermined distance. The overlap distance should be as small as possible to gain the maximum viewing area over the conveyor region, but must be large enough to see the relevant parts of the article, according to the inspection requirements. Calibration of the camera height and other parameters may be performed by a process such as that described in “An Efficient and Accurate Camera Calibration Technique for 3D Machine Vision”, Roger Y. Tsai, Proceedings of IEEE Conference on Computer Vision and Pattern Recognition, Miami Beach, Fla., 1986, pages 364-374.

Light sources 880 are provided to illuminate the article. The light sources preferably provide substantially uniform lighting over the article along the full length of the views through which the inspected article moves and rotates. The lighting is preferably uniform on the surface of the articles and is not necessarily uniform on the flat conveyor surface or plane. By providing uniform lighting, artificial bright patches on the items caused by non-uniform lighting are avoided which may be confused with natural bright patches. The light sources also provide enough light to get adequately bright images of the articles at the conveying speed and rotation speeds required, since short exposure times may be required to reduce motion blur effects.

The cameras and mirrors may be enclosed in a positive pressure enclosure that is supplied by filtered air to reduce the need to clean the mirrors and lenses. As the mirrors and cameras are located substantially above the line of the articles, the amount of dirt and other contaminants that can be expected to reach the mirrors or the enclosure may be reduced.

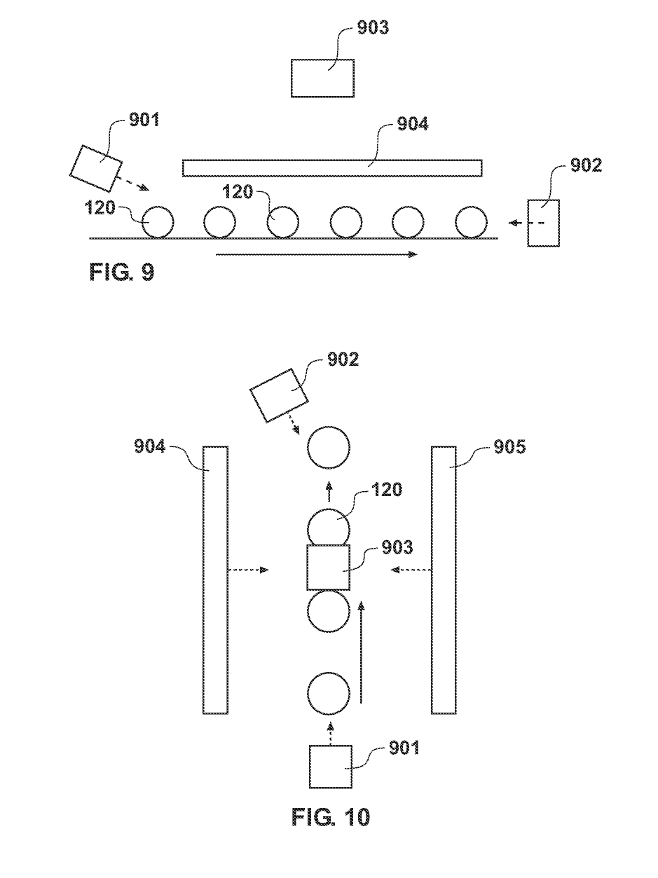

Referring next to FIGS. 9 and 10, in some embodiments one or more cameras 901, 902 may be positioned at or adjacent one or more ends of inspection site in order to capture one or more end view images of the article 120.

In some embodiments a centre of each end view camera 901, 902 is substantially aligned with at least one major axis of the conveyor. In the embodiment shown in FIGS. 9 and 10, the centre of end view camera 901 is in line with the longitudinal axis of the conveyor, but is offset in the vertical direction so as to allow the articles to pass beneath it. End view camera 902 is in line with vertical axis of the articles on the conveyor, but is offset in the lateral axis direction so as to allow the articles to pass to one side of the camera. In other embodiments the camera may be offset in both the vertical and horizontal directions. This embodiment reduces the masking effect of the stems of the fruit, and also places the camera or mirror away from the path of any fruit which falls off the conveyor.

In preferred embodiments the end view cameras 901, 902 are positioned such that their viewing angle is as close as possible to being parallel to the longitudinal axis of the conveyor as possible. To achieve this the offsets mentioned above may be minimised and/or each camera 901, 902 may be placed at the longitudinal extremes of the inspection site.

Although FIGS. 9 and 10 illustrate a system having a vertically offset end view camera 901 and a laterally offset end view camera 902, in some embodiments only one end view camera may be used for each conveyor. In other embodiments (not shown) vertically offset end view cameras 901 may be used at both ends of each conveyor, or alternatively laterally offset end view cameras 902 may be used at both ends.

In embodiments of the invention having multiple conveyors (not shown) one laterally offset end view camera 902 may be positioned equidistant between two adjacent conveyors in order to capture images from both conveyors.

In the embodiment shown in FIGS. 8 and 9 the imaging means comprises a camera 903 mounted above the conveyor and two laterally disposed mirrors 904, 905. However, one or more end view cameras 901, 902 may be used in conjunction with any of the systems described above with reference to FIGS. 1 to 8, or they may be used in conjunction with the imaging systems of the prior art.

In other embodiments (not shown) the system may use one or more mirrors in place of the or each end view camera 901, 902. In some embodiments the end view images are reflected to a camera which is also used for capturing lateral images of the article. In most embodiments the end view camera(s) will provided outside a positive pressure enclosure which is provided for the lateral view cameras/mirrors. Accordingly, the end view cameras may also be provided with a self cleaning system. Independent lighting may also be provided.

By providing an end view of the articles, end cameras 901, 902 increase the proportion of the article which is inspected with adequate resolution, particularly for articles such as cherries and the like which are elongate and so cannot easily be rotated by more than around 180 degrees as they travel through the inspection apparatus.

It will be appreciated that although the embodiments have been described separately, features from one embodiment may be implemented into another, for example the light sources 880.

Where in the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

The embodiments of the invention in which an exclusive property or privilege is claimed are defined as follows:

1. An article inspection apparatus including:
conveying means for conveying an elongate article through an inspection site and rotating the elongate article about a lateral axis of the conveying means as it passes through the inspection site, wherein the total angle of rotation about the lateral axis is limited to substantially 180 degrees; and
an imaging system having at least one image capture means and image directing means arranged to provide to the image capture means a plurality of different views of the inspection site about the lateral axis of the conveying means, the image capture means arranged to capture a plurality of images of the elongate article at different rotational angles as it passes through the inspection site.

2. The apparatus according to claim 1, wherein the conveying means is arranged to convey the elongate article with its longitudinal axis initially aligned with the longitudinal axis of the conveying means and.

3. The apparatus according to claim 1, wherein five views are provided about the lateral axis.

4. The apparatus according to claim 1, wherein the image capture means is one or more cameras, and the image directing means comprise a plurality of mirrors.

5. The apparatus according to claim 1, wherein a plurality of article inspection apparatus are provided in parallel in order to increase the inspection rate of the articles.

6. The apparatus according to claim 5, wherein the image directing means of each inspection apparatus may be arranged to overlap such that the combined width of the plurality of inspection apparatus is less than the total of their individual widths.

7. The apparatus according to claim 1, wherein the views are provided at substantially the same longitudinal location on the conveying means.

8. The apparatus according to claim 1, wherein the views are distributed along two or more longitudinal locations on the conveying means.

9. The apparatus according to claim 8, wherein left-hand views are provided to an image capture means at a first longitudinal location and the right-hand views are provided to a second image capture means at a second longitudinal location.

10. The apparatus according to claim 1, wherein the imaging system is arranged to provide at least one view of the inspection site about a longitudinal axis of the article.

11. The apparatus according to claim 1, wherein the imaging system further comprises at least one further image capture means or image directing means arranged to allow capture of at least one image of the inspection site from a view which is substantially parallel to the longitudinal axis of the conveyor means.

12. The apparatus of claim 11 comprising at least two further image capture means or image directing means arranged to provide views in opposing directions.

13. The apparatus according to claim 1, wherein the articles are cherries.

14. A method of article inspection including:
conveying an elongate article through an inspection site and rotating the elongate article about a lateral axis as it passes through the inspection site, and wherein the total angle of rotation about the lateral axis is limited to substantially 180 degrees; and
capturing a plurality of images of the elongate article at different rotational angles as it passes through the inspection site, the images including a plurality of different views of the inspection site about the lateral axis.

15. The method according to claim 14, further comprising rotating the elongate article substantially 90 degrees about a lateral axis as it passes through each of two inspection sites at different longitudinal locations.

16. The method according to claim 14, wherein at least one of the captured plurality of different views of the inspection site is about a longitudinal axis of the article.

17. An article inspection apparatus including:
conveying means for conveying an article through an inspection site and rotating the article about a lateral axis of the conveying means as it passes through the inspection site; and
an imaging system having at least one image capture means and image directing means arranged to provide to the image capture means a plurality of different views of the inspection site about the lateral axis of the conveying means, the imaging system arranged to provide the different views at two or more longitudinal positions along the conveying means; the image capture means arranged to capture a plurality of images of the article at different rotational angles as it passes through the inspection site.

18. The apparatus according to claim 17, wherein left-hand views are provided to an image capture means at a first longitudinal location and the right-hand views are provided to a second image capture means at a second longitudinal location.

19. The apparatus according to claim 17, wherein the article is elongate and the rotation is limited to substantially 180 degrees.

20. The apparatus according to claim 17, wherein five views are provided about the lateral axis.

21. The apparatus according to claim 17, wherein the image capture means is one or more cameras, and the image directing means comprise a plurality of mirrors.

22. The apparatus according to claim 17, wherein a plurality of article inspection apparatus are provided in parallel in order to increase the inspection rate of the articles.

23. The apparatus according to claim 22, wherein the image directing means of each inspection apparatus may be arranged to overlap such that the combined width of the plurality of inspection apparatus is less than the total of their individual widths.

24. A method of article inspection including:
conveying an article through an inspection site and rotating the article about a lateral axis of the conveying means as it passes through the inspection site; and
capturing a plurality of images of the article at different rotational angles as it passes through the inspection site, the images including a plurality of different views of the inspection site about the lateral axis, the different views being captured at different longitudinal positions along the conveying means.
